(19) United States
(12) Patent Application Publication
(10) Pub. No.: US 2008/0122594 A1
(43) Pub. Date: May 29, 2008

(54) CONTROL OF FLEET VEHICLES WITH COMMON TRANSMITTERS

(75) Inventors: James P. Brecht, Shelby Township, MI (US); Sanjaya K. Dash, Macomb, MI (US); Tejas B. Desai, Troy, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS VDO AUTOMOTIVE CORPORATION, Auburn Hills, MI (US)

(21) Appl. No.: 11/773,535

(22) Filed: Jul. 5, 2007

Related U.S. Application Data
(60) Provisional application No. 60/819,791, filed on Jul. 10, 2006.
(60) Provisional application No. 60/833,887, filed on Jul. 28, 2006.

(51) Int. Cl. G06F 19/00

(52) U.S. Cl. 340/426.11; 701/2

(57) ABSTRACT

A method of controlling fleet vehicles includes the steps of identifying transmitter signals from a select group and an entire group to allow selective operation of certain specific vehicle functions. The method also includes the step of reprogramming a secret key and storing the previous secret key such that transmitters that have not already been programmed can be programmed if they include the old secret key.

### CROSS REFERENCE TO RELATED APPLICATION

The application claims priority to U.S. Provisional Application No. 60/819,791 and 60/833,887 which were both filed on Jul. 10, 2006.

### BACKGROUND OF THE INVENTION

This invention generally relates to a remote entry and start system for fleet vehicles. More particularly, this invention relates to a method of programming and operating a keyless entry and start system for fleet vehicles.

Typically, one or two remote transmitters known as a fob are mated with a single vehicle. The fob and the vehicle controller include identification codes that are used to authenticate transmissions before recognizing and performing the desired operations. However, in fleet applications where many vehicles are operable by many fob's, storage of every applicable identification code, and then comparing received identification codes with the stored codes unacceptably increases wait times. Additionally, not comparing identification codes and providing operation of many different fobs with many different vehicles can result in actuation of a vehicle function, for example unlocking of the doors, for all the vehicles within a fobs transmission range.

Additionally, programming and reprogramming multiple fobs for use with many vehicles also presents a problem where secret codes are utilized to verify authorization to operate any specific vehicle. Old key fobs that have not yet been updated, and do not include the current secret key are not recognized by a vehicle controller and therefore cannot be easily updated.

Accordingly, it is desirable to design and develop a method and system for operating and programming multiple fobs with multiple vehicles.

### SUMMARY OF THE INVENTION

An example system and method of controlling fleet vehicles with a number of different remote transmitters includes the steps of determining the origin of a transmission providing selective access to a certain vehicle functions dependent on the origin of the signal.

The example immobilizer system provides for operation of a fleet including a plurality of vehicles each including a vehicle controller that communicates with a corresponding plurality of transmitters known commonly as a key fob. Each of the key fobs includes a secret key code common to all vehicles within the fleet along with an identification code unique to each fob. A select level of access is allowed for all vehicles in the fleet responsive to received instructions from any fob within the fleet that includes the secret key code. A select second group of fob identification codes are stored within a corresponding select group or single vehicle within the fleet. Transmissions including an identification code that is stored within the vehicle controller provides for an increased level of control and access. If the transmission includes an identification code that does not match then only limited access is allowed.

The example system and method also operates to provide reprogramming of secret key codes for many vehicle controllers and transmitters. Transmitters that include either the current secret key or an old secret key are recognizable by a vehicle controller and therefore are reprogrammable.

These and other features of the present invention can be best understood from the following specification and drawings, the following of which is a brief description.

### BRIEF DESCRIPTION OF THE DRAWINGS

FIG. 1 is a schematic representation of the example method of controlling operation of select vehicles within a fleet of vehicles.

FIG. 2 is a schematic flow diagram of the method of controlling select vehicles and controlling access to select transmitters of a vehicle fleet control system.

FIG. 3 is a schematic representation of a method of re-programming secret keys for a fleet system.

FIG. 4 is a flow diagram illustrating the example steps for re-programming a secret key for a fleet of vehicles.

### DETAILED DESCRIPTION OF THE PREFERRED EMBODIMENT

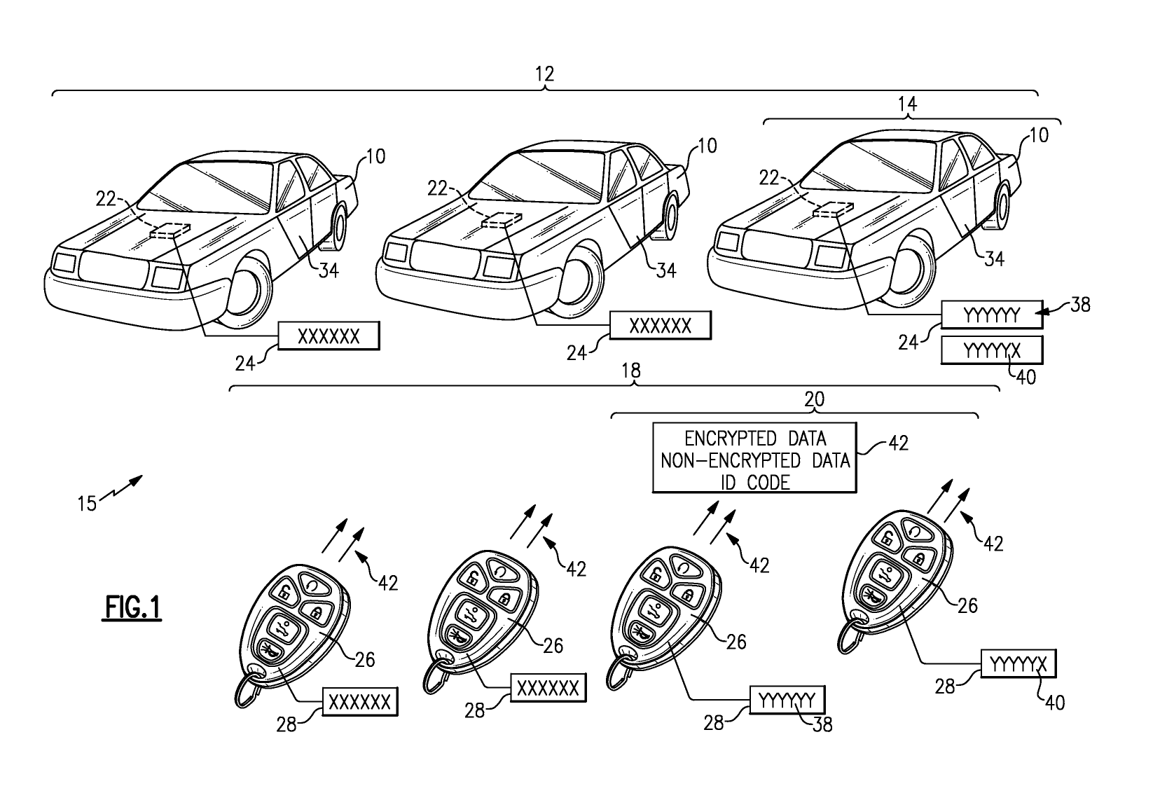

Referring to FIG. 1, an example fleet of vehicles includes a first group 12. The first group 12 includes all the vehicles 10 within the fleet. A second group 14 is defined within the first group 12 and includes a lesser number of vehicles 10. In the illustrated example, only one vehicle is illustrated as belonging to the second group 14, however, several vehicles may belong to the second group 14. Each of the vehicles 10 includes a vehicle controller 22. Each vehicle controller 22 includes a memory device and location 24 that stores a number of identification codes less than all of the identification codes within the example fleet. The vehicle 10 within the second group 14 includes two identification codes 38, 40. Each identification code corresponds to a transmitter 26. The transmitters 26 are also divided into a first group 18 and a second group 20. The first group 18 includes all the transmitters within the fleet that include the proper secret key. Each of the transmitters within the first group 18 is able to selectively actuate certain specified functions of each of the vehicles 10.

The second group 20 is smaller than the first group 18 and includes transmitters that correspond to the second group of vehicles 14. The common link between the transmitters 26 in the second group 20 and the vehicles 10 within the second group 14 is that the vehicles 10 within the second group 14 have stored in the vehicle controller memory devices 24 the identification codes 38, 40 that correspond to the transmitters 26 within the second group 20. Each of the vehicles 10 stores a limited number of identification codes corresponding to certain transmitters within a corresponding group. When a transmission from those specific transmitters 26 is received the received identification code is matched with identification codes stored within the vehicle controller memory 24 to verify the level of access and control authorized.

In the example system, each of the transmitters 26 is operable to actuate a driver's side door 34 and to start the engine of each of the vehicles within the first group 12. As the first group 12 includes all of the vehicles within the fleet, each of the transmitters 26 is authorized to control access to the driver side door 34 and start the engine. This limited access provides the desired functionality of each of the vehicles 10 while limiting access and controlling operation of several vehicles at the same time. As appreciated, if each transmitter had full authorization of each of the vehicles, any transmission from any transmitter 26 could possibly cause operation of several vehicles within range of the transmission. Such operation may not be desirable in specific instances.

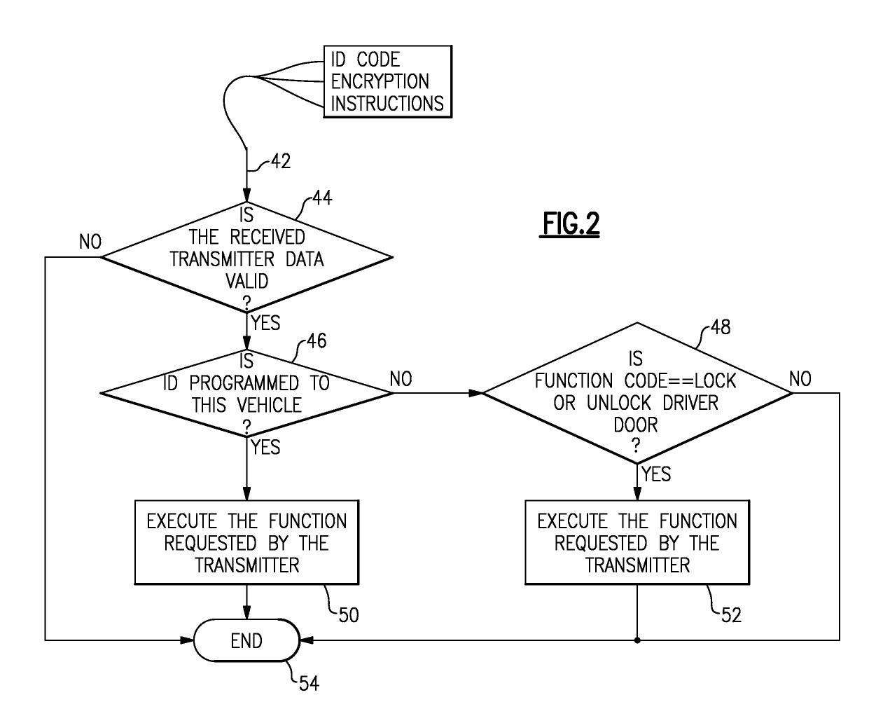

Referring to FIG. 2, a first step of operation at the vehicle controller 22 begins upon receipt of the transmission 42 from one of the transmitters 26. The incoming transmission 42 is evaluated first to determine if it is a valid transmission from at least the first group of transmitters 18 as is indicated at step 44.The transmission 42 can be verified in many different ways. In the example system, a secret key is utilized along with an encrypted signal to provide verification of the incoming signal 42.

Once the incoming signal has been validated, it is determined if an identification code included with the signal 42 matches identification codes that are stored within the vehicle controller memory 24 as indicated at step 46. If the identification code does not match any of the identification codes stored in the vehicle controller 22, then the instructions provided or transmitted with the signal 42 is evaluated. That evaluation occurs as is illustrated in block 48 to determine if the desired operations fall within the limits and parameters that are allowed for a transmitter within the first group. In this example, the allowed operations are to unlock the driver side door and allow operation of the engine. If any other commands are received then those would fall outside of the allowed and acceptable performance from instructions received and no operation would occur at the vehicle 10. However, if the operation is either unlocking the door or operation of the engine then that function is actuated as is indicated at block 52.

Referring back to block 46, if the identification code is recognized by the vehicle then any functions or instructions that are received by transmitter 26 will be actuated as indicated by block 50. The vehicle controller 22 then returns to an exit block 54 then returns back to the validation of any incoming transmissions that it may receive.

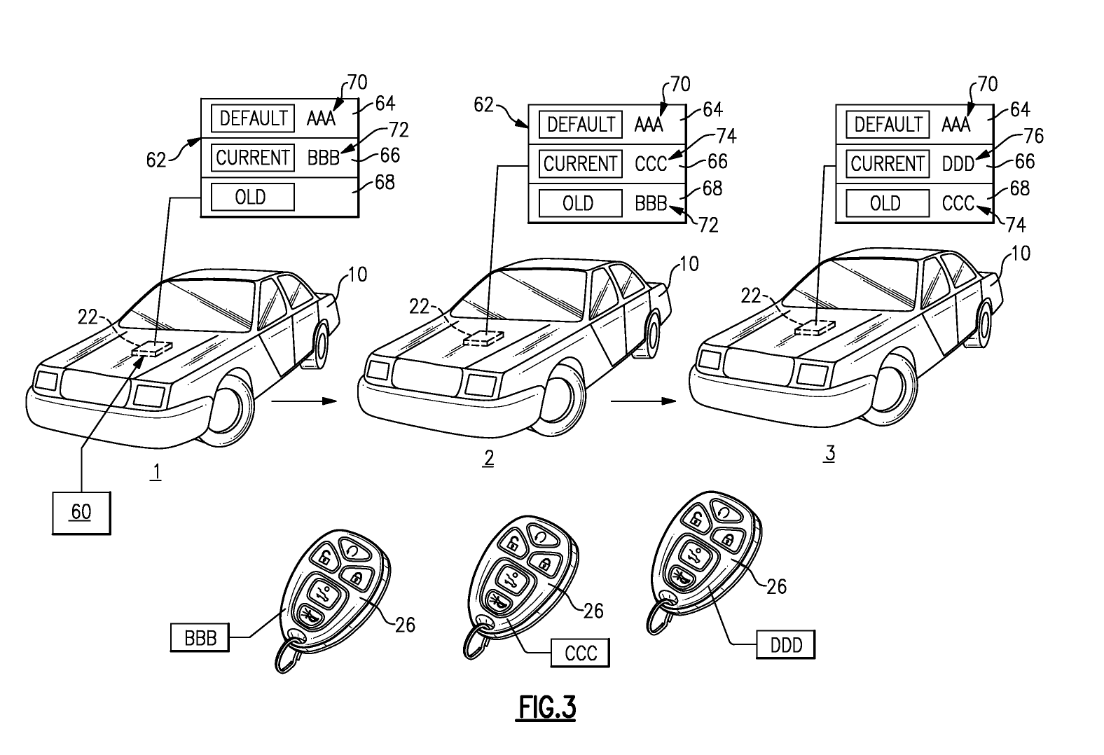

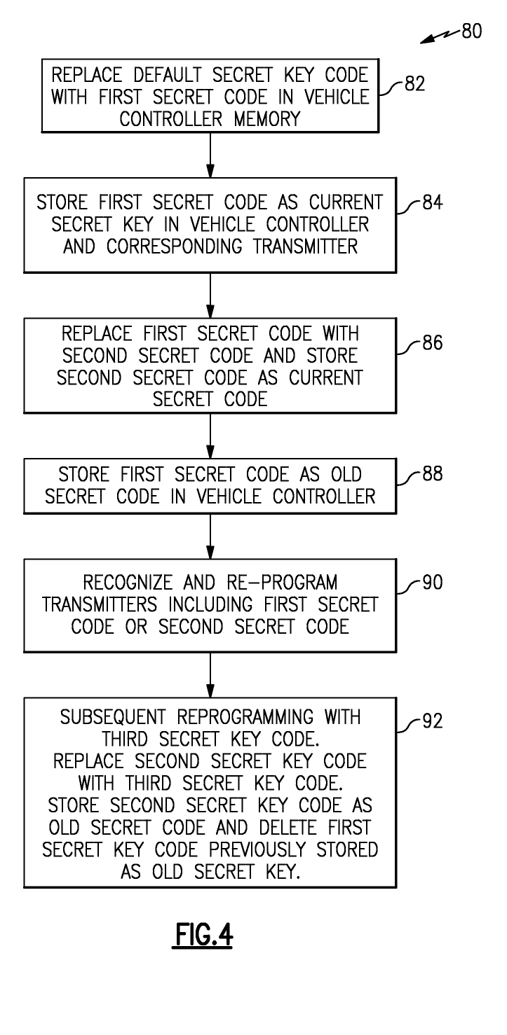

Referring to FIGS. 3 and 4, each transmission from the plurality of transmitters 26 includes an encrypted portion and an unencrypted portion. The encrypted portion is encrypted according to an algorithm that utilizes a secret key along with other data including identification data and button actuation data to prevent unauthorized duplication of transmissions. Along with the encrypted data is unencrypted data including all of the information transmitted within the encryption except for the secret key. The vehicle controller 22 of each vehicle 10 in which the transmitter is authorized to operate includes a corresponding secret key. The secret key is never transmitted over open airwaves and is utilized upon receipt of transmission to verify that that transmission is from an authorized transmitter. In vehicle fleet applications, a secret key is often required to be re-programmed in each of several vehicle controllers 22 and corresponding transmitters 26. Because multiple transmitters 26 are being programmed with multiple vehicles 10, several transmitters must be programmed at different times.

Currently, once a secret key is re-programmed in a vehicle controller 22, any transmitter 26 that does not include that secret key will not be recognized by the vehicle controller 22. This creates the problem in that none of the transmitters 26 would be accepted and reprogrammable once the old secret key has been replaced by a current secret key code. Accordingly, the example system includes a method in which secret key codes are stored in a vehicle controller 22 such that secret key codes from transmitters 26 that have not yet been updated can be recognized for reprogramming purposes.

Each of the vehicles 10 includes the vehicle controller 22 includes a memory location 62 that stores several secret key codes. The initial state includes a default secret key code indicated at 70. This default secret code 70 is as the system originates from the factory and is reprogrammed with a current secret code 72. The current secret code 72 is that code that is utilized for decrypting transmissions 42 received from the transmitter 26. The memory location also includes a memory space 68 for an old secret code. The old secret code is the last secret code that was programmed into the vehicle controller 22 and is utilized to recognize transmitters 26 that have not yet been reprogrammed to the current secret code.

The example method includes the initial step, indicated at 82 in FIG. 4, of replacing a default secret key code 70 with a first secret key code indicated at 72. This first secret key code 72 is stored within the current memory location 66 within the memory device 62 of the vehicle controller 22 as indicated at 84 and shown as step 1 in FIG. 3. Each of the corresponding transmitters 66 is also programmable from the controller 22 to include the first secret code 72. Programming of the vehicle controller 22 is provided by a programming module 60. The programming module 60 is shown schematically and may be facilitated by a hand held device or software generated and run on a portable computer or other device that is capable of communicating with the vehicle controller 22 in a secure manner.

Normal operation is established once the initial program complete and storage of the secret code concluded in both the vehicle controller 22, and each of the plurality of transmitters 26. Normal operation includes the transmission of an encrypted code that is encrypted utilizing the secret key code. This transmission from a transmitter 26 is accompanied by non-encrypted data except for the secret key. Upon receipt of this data by the vehicle controller 22, the encrypted data is decrypted utilizing the stored key code. The decrypted data is then compared to the non-encrypted data to assure validity and authorization of the transmission to operate the various functions of vehicle 10.

When it is desired to reprogram the secret key to replace or ensure certain security needs, the first secret code value 72 is saved in the old memory storage area 68 as indicated at 86. A second secret key code 74 is then stored in the current memory locations 66. The default code 70 remains within the default memory location are not utilized for decryption. The storage of the second secret code 74 and the current memory location 66 is accomplished through programming module 60. The vehicle controller 62 is then utilized to program corresponding transmitters 26 that are in that location. This corresponding programming of the vehicle controllers 22 and corresponding transmitters 26 occurs by communicating commands from the vehicle control 22 to authorize transmitters 26 that previously include recognized codes.

Transmitters that were not programmed during the first cycle will still include the first secret key code 72. Because the vehicle controller 22 remains and still is the first secret key code 72 in the old memory storage area 68 the vehicle controller will be able recognize all transmitters 26 that include transmissions that have been encrypted utilizing the first secret key code 72 or the second secret key code 74 because the first secret key code 72 is stored in old memory storage location 66.

Because the vehicle controller 22 includes the first secret key code 72, transmitters 26 that transmit encrypted data utilizing the old secret will be capable of being reprogramming with the second secret key code 74. The secret key code that is stored in the current memory location 66 is utilized for encryption and decryption for operation of a vehicle.

A third key code 76 can be stored in the current memory location slot 66 and the second key code 74 can be moved to the old memory location slot 68 as is indicated at 88 in FIG. 4. Each update of the secret key increments the secret code key that was current to the old memory location 68 so that it may still communicate and allow reprogramming of transmitters 26 including the old secret key while also allowing updating of the secret key code as is desired.

Reprogramming operations are allowed for transmitters that include secret keys that are stored either in the current memory location 66 or the old memory location 68 as indicated at 90 in FIG. 4. However, because only encryption and decryption is performed utilizing key codes sorting the current memory location 66, those transmissions that are received utilizing old key codes are not authorized to actuate functions of the vehicle until reprogrammed.

Referring to FIG. 4, subsequent reprogramming with a third secret key code 76 will cause the second secret key 74 to be incremented and stored in the old memory slot 68 such that transmitters 26 that include the third secret key code 76 or the second secret key code 74 will be recognized and capable of reprogramming and therefore operation of the vehicle 10. The secret key code that was preciously stored in the old memory location 68 is overwritten and is no longer available for recognition of transmitters including the overwritten secret key code.

The example method and system includes features for operating and programming a keyless entry and immobilizer system for fleet applications to provide desired security and updating capabilities.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of controlling a fleet of vehicles with many different transmitters comprising the steps of:
a) transmitting a signal utilizing a secret key common to transmitters authorized to command all vehicles within the fleet of vehicles;
b) determining if the signal is from a first group of transmitters authorized to command vehicles within the fleet of vehicles;
c) authorizing a limited level of vehicle command capability responsive to the signal being validated as being sent from a transmitter in the first group of transmitters;
d) determining if the signal belongs to a second group of transmitters authorized to command a second group of vehicles within the fleet; and
e) authorizing additional vehicle command capability greater than the limited level responsive to the signal being validated as being sent from a transmitter in the second group of transmitters.

2. The method as recited in claim 1, wherein the limited level of vehicle command capability comprises remote unlocking and locking of a driver side door.

3. The method as recited in claim 1, wherein the limited level of vehicle command capability comprises starting a vehicle.

4. The method as recited in claim 1, wherein the determination if the signal is from a first group of transmitters comprises validating an encrypted portion of a signal with a secret key common to all vehicles within the fleet and all transmitters authorized to operate any vehicles within the fleet of vehicles in a limited capacity.

5. The method as recited in claim 1, wherein the second group of vehicles includes at least one stored identification code corresponding to a transmitter within the second group of transmitters.

6. The method as recited in claim 5, wherein the step of determining if the signal is from a transmitter within the second group of transmitters includes comparing the at least one stored identification code stored within a vehicle within the second group of vehicles with an identification code received as part of the signal.

7. The method as recited in claim 6, wherein the determination that the transmitter belongs to a second group of transmitters provides authentication required to command all functions of a motor vehicle within a corresponding second group of vehicles.

8. The method as recited in claim 6, wherein the second group of vehicles includes a plurality of stored identification codes corresponding to the second group of transmitters.

9. The method as recited in claim 1, comprising more than one of the second group of vehicles and transmitters recognized by each of the second group of vehicles.

10. A method of programming a vehicle immobilization system comprising the steps of:
a) replacing a stored default secret key code within a vehicle controller and each of a plurality of corresponding key fobs with a first secret key code stored as a current key code, where the first secret key is different than the default secret key code;
b) subsequently replacing the first secret key code within a vehicle controller and each of the plurality of corresponding key fobs with a second secret key code;
c) storing the first secret key code within the vehicle controller as an old key code;
d) recognizing and communicating with key fobs including the first secret key code with the vehicle controller; and
e) replacing the first secret key code in the key fobs with the second secret key code.

11. The method as recited in claim 10, wherein the step of recognizing and communicating with each of the corresponding plurality of key fobs includes comparing the current secret key with the secret key stored in the key fob, comparing the old secret key with the secret key stored within the key fob, and recognizing the key fob responsive to a match of the current secret key or the old secret key with the secret key stored in the key fob.

12. The method as recited in claim 10, including the step of replacing the current key code with a third secret key code and storing the second secret key code as the old key code.

13. The method as recited in claim 10, including the step of communicating the secret key code to the vehicle controller with instructions from a programming module and reprogramming each of the plurality of corresponding key fobs with the vehicle controller.

14. The method as recited in claim 10, including resetting current key code to the default key secret key code in the current vehicle controller responsive to a reset command from a programming module.

15. The method as recited in claim 10, wherein the vehicle controller includes a plurality of vehicle controllers in a corresponding plurality of motor vehicles and a corresponding plurality of key fobs that communicate with each of the plurality of vehicle controllers.
